(19) United States
(12) Patent Application Publication
(10) Pub. No.: US 2003/0020242 A1
(43) Pub. Date: Jan. 30, 2003

(54) Drill chuck with inset indicia band

(75) Inventor: Hans-Dieter Mack, Sontheim (DE)

Correspondence Address: THE FIRM OF KARL F ROSS, 5676 RIVERDALE AVENUE, PO BOX 900, RIVERDALE (BRONX), NY, 10471-0900, US

(73) Assignee: ROHM GmbH

(21) Appl. No.: 09/948,279

(22) Filed: Sep. 7, 2001

(30) Foreign Application Priority Data
Jun. 20, 2001 (DE) 20110180.7

(51) Int. Cl. B23B 31/12

(52) U.S. Cl. 279/60; 279/62; 279/158; 279/902

(57) ABSTRACT

A drill chuck has a chuck body centered on an axis and formed with a forwardly open seat and with a plurality of angled guides spaced angularly about the axis and open forward into the seat. Respective jaws slidable in the guides each have a toothed outer edge meshing with a screwthread of a tightening ring rotatable about the axis to axially and radially displace the jaws in the body. An adjustment sleeve rotationally coupled to the ring is rotatable about the axis on the body. It has an outer grip surface of a predetermined outer diameter and an indicia band axially offset from the grip surface and of an outer diameter smaller than the outer grip surface.

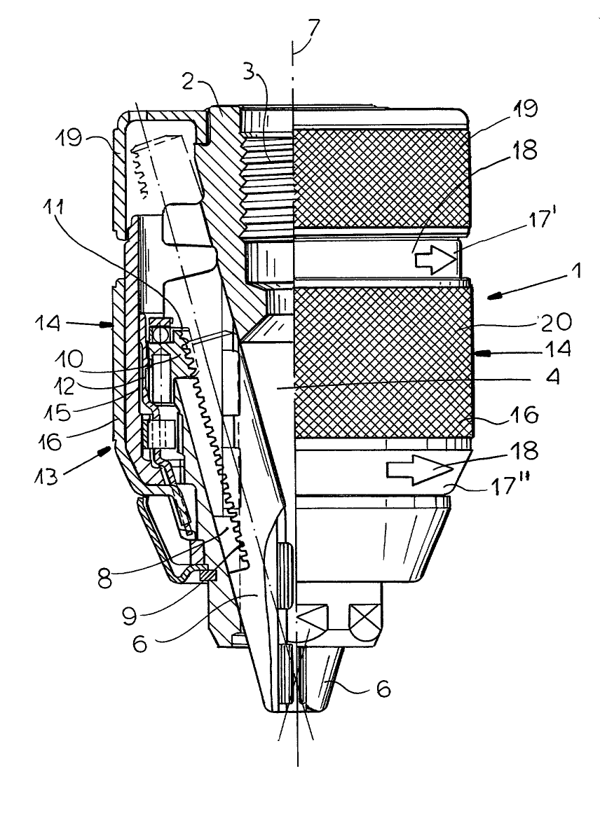

### FIELD OF THE INVENTION

The present invention relates to a chuck. More particularly this invention concerns a hammer-drill chuck.

### BACKGROUND OF THE INVENTION

As described in U.S. Pat. No. 5,765,839, a standard drill chuck has a machined steel chuck body centered on an axis and formed with a rearwardly open threaded bore that receives the spindle of a power unit and a forwardly open seat adapted to receive a tool or workpiece, normally a drill bit. A plurality of angularly spaced angled passages open axially forward into the seat and each receive a respective jaw that can move axially forward and radially inward to grip the bit in the seat and axially back and radially outward to release the bit. Teeth on the radially outwardly directed edges of the jaws mesh with an internal thread of a tightening ring connected to a sleeve surrounding the chuck body. This sleeve can rotate on the body but cannot move axially on the body Thus rotating the sleeve in o one direction tightens the jaws on the object in the seat and opposite rotation frees the object.

In many drills, in particular battery-powered models, the sleeve is gripped by the user so it cannot rotate and the power unit is set to rotate in the necessary direction to tighten or loosen the chuck. Alternately the operator simply manually rotates the sleeve in the appropriate direction for the tightening or loosening operation. This is in comparison to heavy-duty drills which use a geared key that is set in a hole in the chuck body and meshes with teeth at the edge of the sleeve so considerable torque can be brought to bear.

It is standard to provide such a chuck with indicia on the adjustment sleeve indicating which direction to rotate it for tightening and loosening, and that can identify the manufacturer and/or model of the chuck. These indicia are typically embossed or printed on a smooth band adjacent the milled regions adapted to be held by the user. The indicia band is thus merely a smooth region, except at the indicia, that is generally flush with the rest of the outer surface of the adjustment sleeve.

The problem with this construction is that the indicia are easily fouled or damaged and rendered illegible. The band can scrape, for instance, when drilling immediately adjacent a wall so that its indicia are scratched off. Similarly the grit generated during drilling can cover the band and make it impossible to read the indicia thereon.

### OBJECTS OF THE INVENTION

It is therefore an object of the present invention to provide an improved drill chuck.

Another object is the provision of such an improved i drill chuck which overcomes the above-given disadvantages, that is which has an indicia band that is protected against damage.

### SUMMARY OF THE INVENTION

A drill chuck has according to the invention a chuck body centered on an axis and formed with a forwardly open seat and with a plurality of angled guides spaced angularly about the axis and open forward into the seat. Respective jaws slidable in the guides each have a toothed outer edge meshing with a screwthread of a tightening ring rotatable about the axis to axially and radially displace the jaws in the body. An adjustment sleeve rotationally coupled to the ring is rotatable about the axis on the body. It has an outer grip surface of a predetermined outer diameter and an indicia band axially offset from the grip surface and of an outer diameter smaller than the outer grip surface.

Thus with this system the indicia band is set in the chuck body, out of harm's way. The chances of it getting scratched and defaced by contact with a workpiece during drilling are greatly reduced. In addition it is set back from dust and grit that flow over the chuck, for instance during overhead drilling, so that it will stay relatively clean.

The outer grip surface according to the invention is substantially cylindrical and centered on the axis. It is also normally roughened, for instance having a milled surface.

The indicia band in accordance with the invention is axially rearward of the grip surface and is substantially cylindrical. Furthermore the indicia band is smooth. The indicia itself can identify the manufacturer of the chuck and/or give instructions as to how to operate the chuck, such as arrows associated with labels for tightening or loosening.

The sleeve according to the invention forms a second indicia band axially offset from the grip surface and the first-mentioned indicia band. The grip surface lies between the first and second indicia bands. The second indicia band is substantially frustoconical and centered on the axis. It normally is forward of the first band.

The chuck further has according to the invention a grip sleeve fixed to the body and of an outside diameter equal to that of the grip surface. The indicia band lies between the grip sleeve and the grip surface.

### BRIEF DESCRIPTION OF THE DRAWING

The above and other objects, features, and advantages will become more readily apparent from the following description, reference being made to the accompanying drawing whose sole FIGURE is a side view partly in axial section through a drill chuck according to the invention.

### SPECIFIC DESCRIPTION

As seen in the drawing a chuck 1 has a chuck body 2 centered on an axis 7 and formed with a rearwardly open threaded spindle bore 3, a forwardly open tool seat 4, and a passage 5 axially interconnecting them so that, for example, a hammer rod in an unillustrated power unit can act directly on the rear end of an unillustrated tool in the seat 4. Three jaws 6 are slidable in angled guide passages 8 and have toothed outer edges 9 meshing with a tightening ring 10 rotatable about the axis 7 on the body 2. The ring 10 is formed of a plurality of parts and is held in a radially outwardly open groove 11 of the body 2.

A connecting sleeve 12 rotationally connects the ring 10 via a locking system 13 of the type described in above-cited U.S. Pat. No. 5,765,839 with an outer adjustment sleeve 14 that is rotated to radially and axially displace the jaws 6 as is standard in the art. The sleeve 14 is comprised of an inner sleeve part 15 and an outer part 16, the former forming a rear recessed indicia bands 17′ and the latter forming a front indicia band 17″. Both bands 17′ and 17″ bear indicia 18 and the outer sleeve 16 has between them a milled surface 20 of greater outside diameter than either band 17′ or 17″. The chuck body 2 also carries a rear holding sleeve 19 of the same outside diameter as the milled portion 20 of the outer sleeve part 16.

The inner sleeve part 15 is fixed in the outer sleeve part 16 and the two bands 17′ and 17″ are of smaller diameter than the outer part 16, ensuring that the indicia 18 is set radially inward of the outer surface 20 of the part 16. The rear band 17′ is cylindrical and the front band 17″ is frustoconical. The indicia 18 is embossed or engraved in the bands 17′ and 17″.

I claim:

1. A drill chuck comprising:
a chuck body centered on an axis and formed with a forwardly open seat and with a plurality of angled guides spaced angularly about the axis and open forward into the seat;
respective jaws slidable in the guides and each having a toothed outer edge;
a tightening ring having a screwthread meshing with the toothed outer jaw edges and rotatable about the axis to axially and radially displace the jaws in the body; and
an adjustment sleeve rotationally coupled to the ring and rotatable about the axis on the body, the sleeve having an outer grip surface of a predetermined outer diameter and an indicia band axially offset from the grip surface and of an outer diameter smaller than the outer grip surface.

2. The drill chuck defined in claim 1 wherein the outer grip surface is substantially cylindrical and centered on the axis.

3. The drill chuck defined in claim 2 wherein the outer grip surface is roughened.

4. The drill chuck defined in claim 1 wherein the indicia band is axially rearward of the grip surface and is substantially cylindrical.

5. The drill chuck defined in claim 4 wherein the indicia band is smooth.

6. The drill chuck defined in claim 1 wherein the sleeve forms a second indicia band axially offset from the grip surface and first-mentioned indicia band, the grip surface lying between the first and second indicia bands.

7. The drill chuck defined in claim 6 wherein the second indicia band is substantially frustoconical and centered on the axis.

8. The drill chuck defined in claim 8, further comprising
a grip sleeve fixed to the body and of an outside diameter equal to that of the grip surface, the indicia band lying between the grip sleeve and the grip surface.
